(19) United States
(12) Patent Application Publication
(10) Pub. No.: US 2021/0304279 A1
(43) Pub. Date: Sep. 30, 2021

(54) INFORMATION PROCESSING METHOD, ELECTRONIC DEVICE AND COMPUTER-READABLE STORAGE MEDIUM

(71) Applicant: NEC CORPORATION, Tokyo (JP)

(72) Inventors: Wenjuan Wei, Beijing (CN); Chunchen Liu, Beijing (CN)

(73) Assignee: NEC CORPORATION, Tokyo (JP)

(21) Appl. No.: 17/218,527

(22) Filed: Mar. 31, 2021

(30) Foreign Application Priority Data
Mar. 31, 2020 (CN) 202010245515.3
Mar. 31, 2020 (CN) 202010246050.3

(51) Int. Cl. G06Q 30/06; G06Q 30/02

(52) U.S. Cl. CPC G06Q 30/0629; G06Q 30/0201; G06Q 10/0637; G06Q 30/0205; G06Q 30/0639

(57) ABSTRACT

Embodiments of the present disclosure provide an information processing method, electronic device and computer-readable storage medium. The method proposed herein comprises obtaining product information on a plurality of products, the product information at least comprising the output quantity and a target attribute of each of the plurality of products within a period of time, where the output quantity indicates the number of respective products outputted externally within a period of time. The method further comprises determining a causality related to the output quantity by applying the product information to a data processing model, and the causality at least indicates a dependency of the output quantity of each of the plurality of products on the respective target attributes of the plurality of products. The method further comprises determining, based on the causality, from the plurality of products at least one target product affecting a total output metric of the plurality of products. With the embodiments of the present disclosure, by determining a core or key product, it is possible to promote a more pertinent product adjustment so as to improve the overall efficiency or profits.

### FIELD

Embodiments of the present disclosure mainly relate to the field of data processing, and more specifically, to a method for information processing, an electronic device and a computer-readable storage medium.

### BACKGROUND

With the rapid development of information technology, the scale of data has grown rapidly. Under such background and trends, how to use technology such as machine learning to process information more effectively has increasingly attracted extensive attention. For example, entities that need to handle (e.g., design, production or sales) various products might expect a more effective use of information on products, so as to make a trade-off between these products, thereby maximizing efficiency or profits.

### SUMMARY

Embodiments of the present disclosure provide an information processing solution.

In a first aspect of the present disclosure, an information processing method is provided. The method comprises obtaining product information on a plurality of products, the product information at least comprising an output quantity and a target attribute of each of the plurality of products within a period of time, the output quantity indicating the number of respective products outputted externally within a period of time. The method further comprises determining causality related to the output quantity by applying the product information to a data processing model, the causality at least indicating a dependency of the output quantity of each of the plurality of products on the respective target attributes of the plurality of products. The method further comprises determining, based on the causality, from the plurality of products at least one target product affecting a total output metric of the plurality of products.

In a second aspect of the present disclosure, an electronic device is provided. The electronic device comprises: a processor and a memory coupled to the processor, the memory having instructions stored thereon which, when executed by the processor, cause the device to perform acts. The acts comprise: obtaining product information on a plurality of products, the product information at least comprising an output quantity and a target attribute of each of the plurality of products within a period of time, the output quantity indicating the number of respective products outputted externally within a period of time. The acts further comprise determining causality related to the output quantity by applying the product information to a data processing model, the causality at least indicating a dependency of the output quantity of each of the plurality of products on the respective target attributes of the plurality of products. The acts further comprise determining, based on the causality, from the plurality of products at least one target product affecting a total output metric of the plurality of products.

In a third aspect of the present disclosure, a computer-readable storage medium is provided with a computer program stored thereon, the program, when executed by a processor, implementing a method according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following more detailed description of example embodiments of the present disclosure with reference to the accompanying drawings, the above and other objects, features and advantages of the present disclosure will become more apparent, wherein the same reference signs denote the same components, wherein,

FIG. 1 shows a schematic view of an example environment in which a plurality of embodiments of the present disclosure can be implemented;

FIG. 2 shows a flowchart of a product analysis process according to some embodiments of the present disclosure;

FIG. 3 shows a simplified block diagram of product analysis and adjustment according to some embodiments of the present disclosure;

FIG. 4 shows a table representing a causality example according to some embodiments of the present disclosure;

FIG. 5 shows a flowchart of a product adjustment process according to some embodiments of the present disclosure;

FIG. 6A shows a flowchart of one process of determining adjustment information according to some embodiments of the present disclosure;

FIG. 6B shows a flowchart of another process of determining adjustment information according to some embodiments of the present disclosure; and

FIG. 7 shows a block diagram of an example device applicable to implement the embodiments of the present disclosure.

### DETAILED DESCRIPTION OF IMPLEMENTATIONS

Principles of the present disclosure will now be described with reference to several example implementations. Although preferred embodiments of the present disclosure are illustrated in the accompanying drawings, it should be understood these embodiments are discussed only for the purpose of enabling persons skilled in the art to better understand and thus implement the present disclosure, rather than suggesting any limitations on the scope of the present disclosure.

As used herein, the term “includes” and its variants are to be read as open terms that mean “includes, but is not limited to.” Unless otherwise stated, the term “or” is to be read as “and/or.” The term “based on” is to be read as “based at least in part on.” The term “one example embodiment” and “an embodiment” are to be read as “at least one example embodiment.” The term “another embodiment” is to be read as “at least one other embodiment.” The terms “first,” “second,” and the like may refer to different or same objects. Other definitions, explicit and implicit, may be included below.

As used herein, the term “causality” may refer to the association between one or more factors (causes) and one phenomenon or result (effect). Any factor affecting a certain phenomenon or result is one of factors of the phenomenon or result.

As used herein, the term “attribute” of a product may refer to the nature that is unique to the product or which the product has under some circumstances, for example, but is not limited to, size, color, price, material, and the like. The term “target attribute” refers to one or more attributes that are considered or of interest in learning or determining causality.

As used herein, the term “output quantity” may refer to the number of products outputted to external in a period of time. For example, depending on different application scenarios, the “output quantity” may denote product sales volume, customization quantity, production quantity, and the like. The term “a total output metric” may refer to a metric which is used to indicate the output of various types or a plurality of products externally in a period of time. For example, depending on different application scenarios, the “total output metric” may denote the total sales volume, total sales (or total sales profit), total customization quantity, total customization and total production quantity of various types or a plurality of products in a period of time.

As used herein, the term “handle” may refer to one or more of designing, producing and selling products. Product handling entities may refer to entities that handle products, such as selling entities, designing entities, and the like. Similarly, an entity that customizes products from a designing entity may be referred to as a customizing entity, and an entity that purchases products from a selling entity may be referred to as a purchasing entity.

As mentioned above, for an entity that handles (e.g., designs, production or sales) various types of products at the same time, it is desirable to make more effective utilization of information on products, so as to make tradeoffs between these products, thereby maximizing efficiency or profits. As an example only, an entity (such as a retail mall) that simultaneously sells various types of products might expect to make product pricing policies or product selection policies based on product sales. An entity that designs a plurality of products at the same time might expect to make product modification (e.g., modification to size and color) policies based on product customization or ordering.

In conventional solutions, in order to solve these demands, a prediction model about output quantity or total output metric is usually obtained through simulation modeling. Then, attributes of various types of products are determined based on the prediction model. However, these conventional solutions are only based on mathematical models without considering the inherent association or influence between these products and their attributes.

Inventors of the present application realized that during activities such as product design, production, sales and the like, some attributes of a product such as size, color, price and so on usually affect the product popularity or user demands on the product and further affect the output quantity of the product. In addition, there are mutual effects between different products, especially different products of the same type. For example, as two products of the same type, the size and price of one product will affect the popularity of another product.

In view of this, inventors of the present application realized that to increase the total output metric of various types or a plurality of products, it should be considered which factors influence the output quantity of products and how these factors influence. Further, a core product of the plurality of products may be determined based on the determined impact factors and way of influence. Then a corresponding policy may be specified for increasing the total output metric. For example, inventors of the present application realized that to increase overall sales, a product selling entity needs to understand which key factor influences the product sales volume and how it influences, so as to determine core value products and customize respective policies to increase overall sales.

According to embodiments of the present disclosure, a product analysis and adjustment solution is provided. In this solution, by processing product information including different source data and using automated causality learning technology, a causality related to an output quantity of a product may be determined, the causality indicating which factors influence the output quantity of the product. Then, a core product or a key product of a plurality of products may be determined based on the causality. For example, the core product or key product may be a product that exerts greater impact on the total output metric of the plurality of products. Further the causality may be used to determine or provide an adjustment scheme or policy for the core product or key product, so as to increase or even maximize the overall efficiency or profits of the plurality of products. With embodiments of the present disclosure, by determining the core product or key product, products may be adjusted more pertinently, so that the product handling efficiency or profits may be improved effectively.

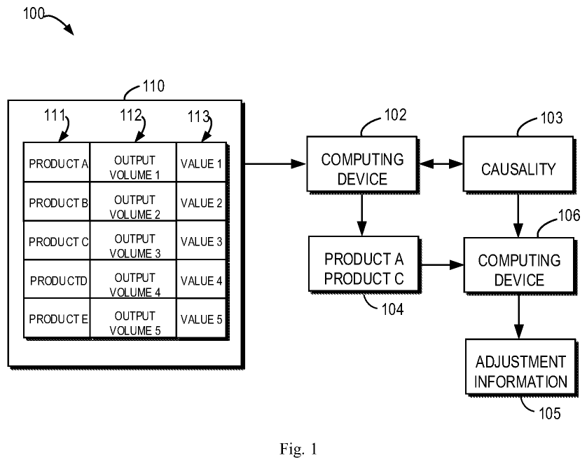

Embodiments of the present disclosure will be described with reference to the accompanying drawings. FIG. 1 shows a schematic view of an example environment 100 in which a plurality of embodiments of the present disclosure can be implemented. In the example environment 100, a computing device 102 processes product information 110 related to a plurality of products, to determine a causality 103 related to the output quantity of products and target product information 104 related to at least one target product.

The product information at least includes a target attribute and the output quantity of each of the plurality of products in a period of time. In FIG. 1, column 111 of example product information 110 denotes different products, column 112 denotes output quantities, column 113 denotes target attributes. In this example product information, there are shown output quantities (specifically, values of output quantities) and target attributes (specifically, values of target attributes) of products A-E. The period of time may be any length of time considered or counted, for example, one day, one week, one month, one quarter, one year, and the like. Although the product information 110 is shown in the form of a table, this is merely exemplary, without limiting the scope of the present disclosure.

In addition, although in the example of FIG. 1 each product corresponds to only one output quantity, in some embodiments the output quantity may further be refined. For example, when the same product is associated with a plurality of product handling entities, the output quantity of one product (e.g., product A) may be refined as output quantities corresponding to the plurality of product handling entities. For example, when product A is sold by a plurality of selling entities, output quantity 1 may be refined as including respective sales sold by the plurality of selling entities. In another example, when product A is ordered by a plurality of entities, output quantity 1 may be refined as including quantities ordered by the plurality of entities.

As one example, the output quantity may be sales volume of products A-E in a period of time, the target attribute may be prices of products A-E in the period of time, and the corresponding total output metric (not shown) may be the total sales of products A-E in the period of time. This example may also be referred to as a product sales example. As another example, the output quantity may be the customization quantity or ordering quantity of products A-E in the period of time, the target attribute may be sizes (e.g., widths, heights of beds) of products A-E, the corresponding total output quantity (not shown) may be the total customization quantity or ordering quantity of products A-E in the period of time. The further example may also be referred to as a product designing example.

As used herein, the term “a plurality of products” may refer to different types of products, products of the same type but different specifications, or a combination thereof. As one example only, product A may be a double bed, product B may be a double bed with a different size to product A, product C may be a single bed, product D may be a closet, and product E may be a television stand. In addition, it should also be understood that although FIG. 1 illustrates only five products A-E, this is merely exemplary but not limiting, and the embodiments according to the present disclosure may include more or less products.

Furthermore, in some embodiments, the product information 110 may include, besides the output quantity and target attribute, other information such as historical output situation, geographical location information and the like, as to be described below.

The causality 103 may represent or describe a factor affecting the output quantity of each of products A-E, and such factors at least include the target attributes of products A-E. The target product information 104 may represent at least one target product of the plurality of products A-E affecting the total output metric, which are target products A and C in this example. In some embodiments, the target product is determined by the computing device 102 based on the causality 103.

A computing device 106 may obtain the causality 103 and the target product information 104, thereby determining adjustment information 105 for the target products A and C. The adjustment information 105 may at least include the adjustment mode for the target attribute of the target products A and C, for example, a change to an attribute value of the target attribute. Additionally, the adjustment information 105 may further include a total output metric change corresponding to the adjustment mode. In the above-mentioned product design example, the adjustment information 105 may include a change to sizes of the target products A and C, and may further additionally include a predicted of change of the total customization quantity caused by the change.

The computing devices 102 and 106 may be any appropriate computing devices such as stationary computing devices, and may also be portable computing devices such as mobile phones, tablet computers and the like. In addition, although the computing devices 102 and 106 are not separately shown in FIG. 1, it should be understood that in some embodiments the computing devices 102 and 106 may be the same computing device, or acts or modules to be described with reference to the computing devices 102 and 106, respectively, may be implemented at the same physical device.

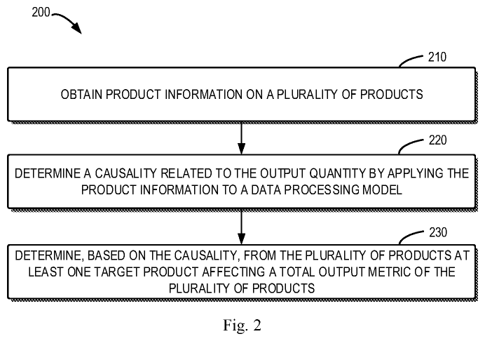

With reference to FIG. 2, this figure shows a flowchart of a product analysis process 200 according to some embodiments of the present disclosure. The process 200 may be implemented by the computing device 102 of FIG. 1. For purposes of discussion, the process 200 will be described in conjunction with FIG. 1.

At block 210, the computing device 102 obtains product information 110 related to a plurality of products A-E. The product information 110 at least includes an output quantity (e.g., column 112) and a target attribute (e.g., column 113) of each of the plurality of products A-E in a period of time, the output quantity indicates the number of respective products outputted externally in the period of time. For the example of product sales, the product information 110 may at least include the sales volume and price of each of the plurality of products A-E within a week. For the example of product design, the product information 110 may at least include a characteristic size of each of the plurality of products A-E and the customization quantity within a week.

In some embodiments, the product information 110 may further include other attribute information besides the target attribute. For example, in the case that the target attribute is price, other attribute information may include the category of the corresponding product (such as bed category, kitchen category), feature size (length, width and height), color and the like. In another example, in the case that the target attribute is size, other attribute information may include the category (such as bedding, kitchen), price, color and the like of the corresponding product.

In some embodiments, the product information 110 may further include historical information about the plurality of products A-E, for example, the historical target attribute and/or historical output quantity of each of the plurality of products A-E before this period of time. For example, regarding the example of product sales, if a product analysis is performed on a weekly basis, the historical information may include the prices and sales quantities of the plurality of products A-E one week, two weeks or three weeks prior to this period of time.

In some embodiments, the product information 110 may further include position information associated with each of the plurality of products A-E. For example, such position information may indicate a position of an entity handling the corresponding product, and/or indicate a position of an entity that receives outputted products. In a product sales example, the position information may include a geographical position where a sales entity (e.g., a retail mall) of a corresponding product is located, for example, the size of the city (whether it is a first-tier city), and a specific location (e.g., urban or suburban areas) where the mall is located. In the example of product design, the position may include a geographical position of an entity (e.g., an individual, product sales entity) that orders or customizes the corresponding product, and/or the geographical position of the design entity of the corresponding product.

In some embodiments, the product information 110 may further include information of operations (also referred to as “auxiliary operations”) related to at least some of the plurality of products A-E, such operations being used to facilitate outputting of products externally. In the example of product design, such information may include whether one or more of the plurality of products A-E is vigorously promoted, for example, whether they are placed in the front position in product manuals, whether product advertisements are placed, and the like. In the example of product sales, such information may include whether one or more of the plurality of products A-E are promoted (e.g., discounted), and whether posters are placed on the sales premises, and the like.

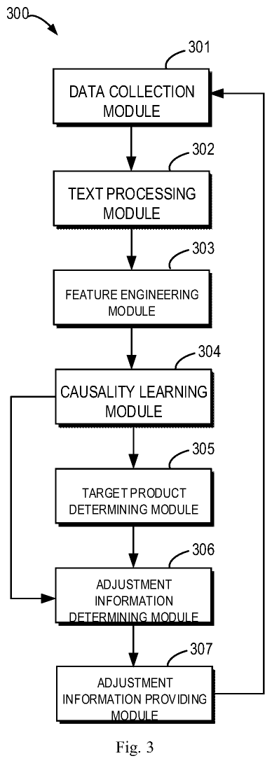

With reference to FIG. 3, this figure shows a simplified block diagram of product analysis and adjustment according to some embodiments of the present disclosure. The act of obtaining product information described with reference to block 210 may be performed by, for example, a data collection module 301. For example, the data collection module 301 may retrieve or read at least part of the product information 110 from a database of the product handling entity.

Still with reference to FIG. 2, at block 220, the computing device 102 determines a causality 103 related to the output quantity by applying the product information 110 to a data processing model. The causality 103 related to the output quantity at least indicates the dependency of the output quantity of each of the plurality of products A-E on the respective target attributes of the plurality of products A-E. The data processing model may be any appropriate model based on causality (linear/non-linear) learning technology. The data processing model may also be any appropriate model that is able to determine the causality by using the product information 110.

The causality 103 may indicate one or more factors (also referred to as key factors) affecting the output quantity of the product and their impact modes, and the one or more factors at least includes the target attribute of the product. In the case that the product information 110 includes other information, the one or more factors may further include factors such as historical output situation, geographical position, in addition to the target attribute.

In some embodiments, the computing device 102 may pre-process the product information 110 for use in the data processing model. The pre-processing of the product information 110 may include text processing, feature engineering or a combination thereof. With reference to FIG. 3, description is presented below to text processing and feature engineering.

A text processing module 302 may be used to process text information in the product information 110 so as to obtain a corresponding quantitative representation or feature representation. For example, the above-mentioned position information and information about auxiliary operations are usually provided in the form text. The text processing module 302 may obtain a quantitative feature representation of the product handling entity based on position information, for example, to which type of entities one or more product handling entities belong (e.g., identifying the scope of the entity). In an example of product sales, this feature representation may indicate whether the one or more product handling entities are first-tier city stores, second-tier city stores, and the like. Based on the information about auxiliary operations, the text processing module 302 may determine the feature representation indicating whether the one or more products are promoted during this period of time (e.g., one week), the promotion intensity, and the like. In the example of product sales, this feature representation may indicate whether one or more products have promotions, the intensity of the promotion, and the like in the current week.

A feature engineering module 303 may perform a data analysis on the product information or the quantitative product information 110 so as to mine a new feature with physical meaning. In the embodiment that the product information 110 includes historical information about the plurality of products A-E, the feature engineering module 303 may generate a timing feature indicating or describing delay characteristics of the product output. For example, in an example of product design, the timing feature may include the product customization quantity/size last week, the product customization quantity/size of the last two weeks, and the like. In another example, in the example of product sales, the timing feature may include the product sales/price last week, the product sales/price of the last two weeks, and the like.

In the case that the product information 110 includes the historical output quantity, the feature engineering module 303 may identify time characteristics of this period of time based on the comparison between the historical output quantity and the output quantity in this period of time (i.e., the considered period of time). The time characteristics may indicate whether this period of time is a peak period for outputting products externally. For example, if the output quantity of products exceeding a certain ratio during this period of time exceeds the historical output quantity, then the period of time may be identified as a peak period. For example, the feature engineering module 303 may make a special time stamp. Such a special time may include, for example, a period of time corresponding to public holidays (such as the National Day Golden Week), a special period of time related to the product handling entity (such as the anniversary of the sales entity) and the like. In such embodiments, a causality learning module 304 may determine the time dependency of the output quantity of each of the plurality of products A-E based on the identified time characteristics, for example, with reference to column 409 of Table 400 to be described below.

In the case that the product information 110 includes position information, based on the output quantity of at least some of the plurality of products A-E, the feature engineering module 303 may cluster a plurality of geographical positions indicated by the position information. A clustering label associated with the product handling entity may be obtained by clustering. For example, the feature engineering module 303 may perform clustering based on information of products of the plurality of products A-E whose output quantity exceeds a threshold value or ranks in the front. In the example of product sales, sales entities may be clustered. A result of clustering may indicate whether a sales entity belongs to the first type of stores (e.g., corresponding to new stores), the second type of stores (e.g., corresponding to special stores such as flagship stores). In the example of product design, customization entities may be clustered. A result of clustering may indicate whether a customization entity belongs to the first type of entities (e.g., corresponding to individuals), the second type of entities (e.g., corresponding to groups, organizations, etc.). In such embodiments, the causality learning module 304 may determine, based on the result of clustering, the position dependency of the output quantity of at least some of the plurality of products A-E, for example, with reference to columns 406 and 407 of Table 400 to be described below.

Based on the product information 110 and the pre-processed product information 110, the causality learning module 304 determines a causality 103 related to the output quantity of the product by using any appropriate causality learning technology. The causality 103 may indicate a key factor affecting the output quantity of the product and its impact mode.

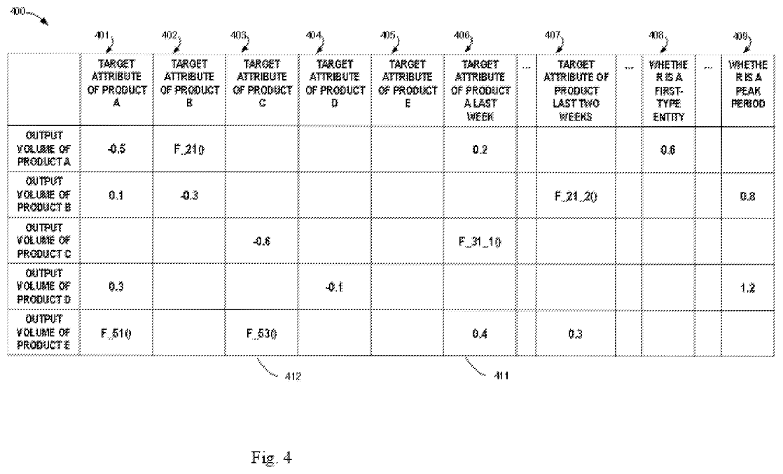

FIG. 4 shows Table 400 representing a causality example according to some embodiments of the present disclosure. Table 400 is merely exemplary and is not intended to be limiting. The causality 103 may indicate less or more dependency than shown in Table 400, and the causality 103 may also indicate the dependency in other forms besides a table.

In some embodiments, the causality 103 may only include columns 401-405 of Table 400, i.e., indicating the dependency of the output quantity of the product on the target attribute of the product. In the case that the product information 110 includes the historical output quantity, the causality 103 may additionally include columns 406, 407 and the like. In the case that the product information 110 includes the position information and/or feature engineering processing is performed on the position information (as described with reference to the feature engineering module 303), the causality 103 may additionally include column 408, i.e., representing the dependency of the output quantity of the product on a related entity (e.g., a handling entity, a customizing entity). In the case that feature extraction is performed on the historical output quantity in the product information 110, the causality 103 may additionally include column 409, i.e., indicating the dependency of the output quantity of the product on the fact whether the considered period of time is a peak period (e.g., the National Day Golden Week).

A non-empty element in Table 400 indicates that the corresponding output quantity is dependent on a corresponding factor (referred to as a key factor). An element that is a value (e.g., element 411) may indicate that the corresponding “cause” has a linear impact on the “effect,” and an element that is an expression (e.g., element 412) may indicate that the corresponding “cause” has a non-linear impact on the “effect.” As an example, for the output quantity of product A, key factors include the target attribute of product A, the target attribute of product B, the target attribute of product A last week, and whether the related entity belongs to the same type of entities. The target attribute (e.g., price) of product A has a linear impact on the output quantity of product A, i.e., every time the target attribute changes by 1, the output quantity will change by −0.5, while the target attribute of product B has a non-linear impact on the output quantity of product A, with an impact relationship of F_21( ) representing a non-linear relationship. Other elements in Table 400 have similar meaning and thus are not repeated here. In addition, an empty element in Table 400 indicates that the corresponding output quantity is not dependent on the corresponding factor, for example, the output quantity of product A is not dependent on the target attribute of product C.

Still with reference to FIG. 2, at block 230, the computing device 102 determines, based on the causality 103, from the plurality of products A-E at least one target product affecting the total output metric of the plurality of products A-E. For example, in the example of FIG. 1, products A and C are determined as target products. The target product may be regarded as a core value product whose target attribute has certain impact on the output quantity of other plurality of products.

Determining the at least one target product from the plurality of products A-E may be based on one or more criteria. In some embodiments, such criteria may include whether the ratio of the output quantity (and/or output metrics) of the product to the total output metric exceeds a threshold ratio. The product whose ratio exceeds the threshold ratio may be selected as a candidate of the target product.

Alternatively or additionally, in some embodiments, such criteria may further include whether the number of other products of products A-E whose output quantity is dependent on the target attribute of a certain product exceeds a threshold number, or in other words, whether the number of other products affected by the target attribute of a certain product exceeds the threshold number. The product for which the number exceeds the threshold number may be selected as a candidate of target products. In the example of FIG. 4, other products affected by the target attribute of product A include products B, D and E.

For example, the computing device 102, for example, a target product determining module 305 shown in FIG. 3 may, for a certain, some or each of products A-E, determine, based on the dependency indicated by the causality 103, the number of other products whose output quantity is dependent on the target attribute of the product. If the number exceeds the threshold number, then the target product determining module 305 may determine the product as a candidate product in a set of candidate products.

Alternatively or additionally, in some embodiments, such criteria may further include whether the change of total output metric caused by a change of the target attribute of the product exceeds a threshold change. The product for which the change of total output metric exceeds the threshold change may be selected as a candidate of target products. In the example of product sales, these criteria may include whether the total sales change of products A-E exceeds a threshold change when a certain product is price off or discounts (e.g., 10% off). In the example of product design, these criteria may include whether the change of total customization quantity of products A-E exceeds a threshold change when the size of a certain product changes by a certain percentage (e.g., 10%). The target product determining module 305 may utilize the causality 103 outputted by the causality learning module 304 to determine or predict the change of total output metric.

For example, based on the dependency indicated by the causality 103, the target product determining module 305 may, for a certain, some or each product of products A-E, determine the change of the total output metric caused by a predetermined change of the target attribute of the product. If the change of the total output metric exceeds a threshold change, then the product may be determined as a candidate product in a set of candidate products.

The above multiple criteria may be used separately or jointly. When used jointly, the target product determining module 305 may use the multiple criteria in parallel. For example, the target product determining module 305 may determine a plurality of sets of candidate products by applying the above multiple criteria, respectively, and then determine a candidate product in the intersection of the plurality of sets of candidate products as the target product. Alternatively, when used jointly, the target product determining module 305 may use the plurality of criteria sequentially. For example, the target product determining module 305 may first apply one criterion to filter from the plurality of products A-E one or more products that do not meets the criterion, and then apply other criteria to the remaining products, thereby determining the target product.

As an example only, in an example of product sales, a product like the following may be considered to be a target product or core value product: a product having a high proportion of product sales (for example, >5%), the product price has an impact on the sales of other products (for example, >10 types), and a discount (for example, 10% off) of the product price causes a big increase in the total sales (for example, the top three or exceed the threshold). In addition, it should be understood that the above mentioned specific values of the discount and the size change are merely exemplary rather than limiting, and any appropriate discount and size change are included in the scope of the present disclosure.

In some embodiments, the computing device 102 may provide information on the at least one target product to an object associated with the plurality of products A-E. The information on the at least one target product may include which products or products is/are the target product(s), and may also include other information, for example, the number of or what are other products affected by the target attribute of the target product, the change of the total output metric caused by a predetermined change of the target attribute of the target product and the like. The object associated with the plurality of products A-E may include a handling entity of the plurality of products A-E, for example, a sales entity, a designing entity and the like.

Some embodiments of information processing and data analysis have been described with reference to FIGS. 1-4. In these embodiments, the core or key product of the plurality of products may be determined by processing product information that includes different source data and using automated causality learning technology. Information related to the core or key product may provide guidance or reference for the product handling entity. For example, the product handling entity may make or adjust a policy according to the core or key product information, thereby optimizing and even maximizing the efficiency or profits. For example, in an example of product design, a product designing entity may spend more cost on the size design of the core or key product. In another example, in the example of product sales, a product sales entity may increase the total sales by adjusting the price of the core or key product.

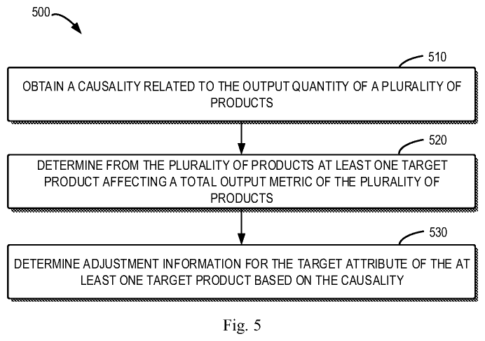

In some embodiments, the target attribute of the product may be adjusted using information processing. FIG. 5 shows a flowchart of a product adjusting process 500 according to some embodiments of the present disclosure. The process 500 may be implemented by the computing device 106 in FIG. 1. For the purpose of discussion, the process 500 will be described in conjunction with FIG. 1 and FIG. 3 additionally.

At block 510, the computing device 106 obtains a causality 103 related to the output quantity of the plurality of products A-E. The causality 103 at least indicates the dependency of the output quantity of each of the plurality of products A-E on the respective target attributes of the plurality of products A-E, the output quantity indicating the number of respective products outputted to externally in a period of time. The causality described herein is the same as that described with respect to the process 200 and thus is not detailed here.

In some embodiments, the computing device 106 may receive the causality 103 related to the output quantity of the plurality of products A-E from other devices (e.g., the computing device 102) or a data source. For example, an adjustment information determining module 306 implemented at the computing device 106 may receive the causality 103 from the causality learning module 304. In some embodiments, the computing device 106 may perform the above process 200 to determine the causality.

At block 520, the computing device 106 determines from the plurality of products A-E at least one target product affecting the total output metric of the plurality of products A-E. The target product may be regarded as a core product or a key product whose target attribute has certain impact on the output quantity of other products, just as described with respect to the process 200.

In some embodiments, the computing device 106 may determine the at least one target product as described with reference to block 230. For example, the computing device 106 may determine the target product by using one or more of the criteria described with reference to block 230.

In some embodiments, the computing device 106 may determine the target product based on other information besides the causality. For example, the computing device 106 may determine the target product only based on the fact whether the ratio of the output quantity of the product to the total output metric exceeds a threshold ratio. In some embodiments, the computing device 106 may receive, from the computing device 103, the determination of the target product of the plurality of products A-E.

At block 530, the computing device 106 determines adjustment information 105 for the target attribute of the at least one target product A and C based on the causality 103. Regarding the example in FIG. 1, the adjustment information 105 may at least include an adjustment mode for the target attribute of the target products A and C, for example, a change of the attribute value of the target attribute. The adjustment information 105 may additionally include the change of total output metric corresponding to the adjustment mode. In an example of product design, the adjustment information 105 may include a change of the size of the target products A and C, and may additionally include a predicted change of total customization volume resulting therefrom. In an example of product sales, the adjustment information 105 may include a change of the price of the target products A and C (e.g., respective discounts), and may additionally include a predicted change of total sales resulting therefrom.

In some embodiments, the computing device 106 (e.g., an adjustment information providing module 307) may provide the adjustment information 105 to an object associated with the plurality of products A-E so that the associated object can apply, to the at least one target product, the adjustment indicated by the adjustment information 105, for example, adjusting the size of the target product, discounting the target product and the like. In some embodiments, the computing device 106 may further obtain the adjusted output quantity of each of the plurality of products A-E after applying the adjustment. The computing device 106 may update or further correct the causality model by applying the adjusted output quantity to the data processing model (e.g., the causality learning model described with reference to the process 200). For example, the adjustment information providing module 307 may obtain the adjusted output quantity from the associated object and deliver the adjusted output quantity to the data collection module 301 so as to update the causality.

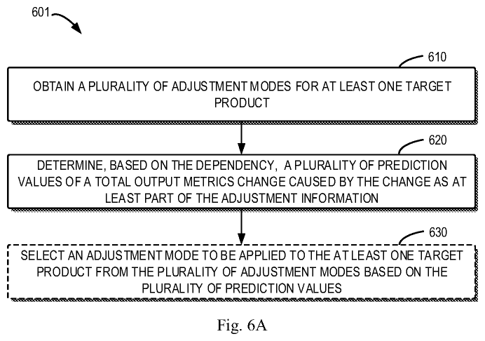

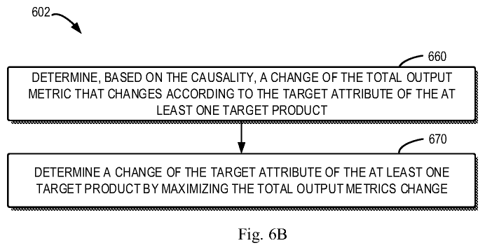

At block 530, the computing device 106 may determine the adjustment information 105 in various ways. In some embodiments, the computing device 106 may compare different adjustment modes (also referred to as policies) for the at least one target product. With reference to FIG. 6A, this figure shows a flowchart of a process 601 of determining adjustment information according to some embodiments of the present disclosure. The process 601 may be regarded as a specific implementation of block 530.

At block 610, the computing device 106 (e.g., the adjustment information determining module 306) obtains a plurality of adjustment modes or policies for the at least one target product. Each of the multiple adjustment modes includes a change of the target attribute of the at least one target product. For example, one of the plurality of adjustment modes may include what changes will be made to the target attribute of the target product A, for example, size reduction or increase in proportion, price reduction or increase in proportion and the like, whiling keeping the target attribute of the target product B unchanged at the same time. Another one of the plurality of adjustment modes may include what changes will be made to the target attribute of the target products A and B. A further one of the plurality of adjustment modes may include what changes will be made to the target attribute of the target product B while keeping the target attribute of the target product A unchanged at the same time.

In some embodiments, the computing device 106 may provide information on the at least one target products to the object associated with the plurality of products A-E and obtain at least part of the plurality of adjustment modes from the associated object. The information on the at least target product and the associated object are as described with reference to FIG. 2. The adjustment mode obtained from the associated object may be one or more policies made by the associated object based on the information on the target product.

Alternatively or additionally, in some embodiments, the computing device 106 may determine one or more adjustment modes for the target product by itself. For example, the computing device 106 may generate one or more adjustment modes by permuting and combining different changes of the target attribute and different target products. In an example of product sales, different changes may include a price unchanged, a 10% discount, a 20% discount and the like.

At block 620, based on the dependency indicated by the causality 103, the computing device 106 determines multiple prediction values of the change of total output metric caused by the change, as the at least part of the adjustment information 105. Each prediction value corresponds to one of the plurality of adjustment modes. The computing device 106 utilizes the learned causality to predict the total output metric change under different adjustment modes or policies, thereby obtaining an optimal policy and the corresponding total output metric value (absolute or relative).

For example, in an example of product sales, the plurality of adjustment modes or policies may include: adjustment mode 1 in which the target product A is 10% off and the target product B is kept unchanged; adjustment mode 2 in which the target product A is 20% off and the target product B is kept unchanged; and adjustment mode 3 in which both the target products A and B are 10% off. With the causality 103, it may be determined that the total sales will increase by 80,000 under adjustment mode 1, 78,000 under adjustment mode 2 and 73,000 under adjustment mode 3. The computing device 102 may use the predicted change of total output metric corresponding to different adjustment modes or policies as at least part of the adjustment information 105 so as to be provided to the associated object, for example, a product sales entity or product designing entity. It should be understood that the above mentioned adjustment modes and their changes (e.g., specific discounts) are merely exemplary rather than limiting.

In some embodiments, at block 630, based on the plurality of prediction values, the computing device 106 may select an adjustment mode to be applied to the at least one target product from the plurality of adjustment modes. For example, the computing device 106 may determine an adjustment mode with the largest positive change in the total output metric as the adjustment mode to be applied. For the above example, the computing device 106 may select the adjustment mode 1 as the adjustment mode to be applied.

At block 530, in some embodiments, the computing device 106 may determine the adjustment mode through optimization learning to generate the adjustment information. With reference to FIG. 6B, this figure shows a flowchart of another process 602 of determining adjustment information according to some embodiments of the present disclosure. The process 602 may be regarded as a specific implementation of block 530.

At block 660, based on the causality 103, the computing device 106 determines a change of total output metric that changes according to the target attribute of the at least one target product A and C. For example, the computing device 106 further learns an output quantity prediction formula of the at least one target by using the learned causality 103. Further, it is possible to obtain the expression of change of total output metric with the target attributes of the target products A and C as independent variables.

At block 670, the computing device 106 determines the change of the target attribute of the at least one target product A and C as the at least part of the adjustment information 103 by maximizing the change of total output metric. For example, the computing device 106 may maximize the change of total output metric expressed by the expression of change of total output metric under a given constraint condition, so as to determine an adjustment mode that maximizes the efficiency or profits, for example, the optimal size combination or the optimal pricing combination.

The process of determining adjustment information for the target attribute of the target product has been described with reference to FIGS. 5, 6A and 6B. In such embodiments, a corresponding policy for the core product or key product may be customized using the causality, so as to improve and even maximize the overall efficiency or profits of a plurality of products.

Although the processes 200 and 500 have been described with reference to FIGS. 2 and 5 respectively, it should be understood that in some embodiments, the processes 200 and 500 may be combined to one process.

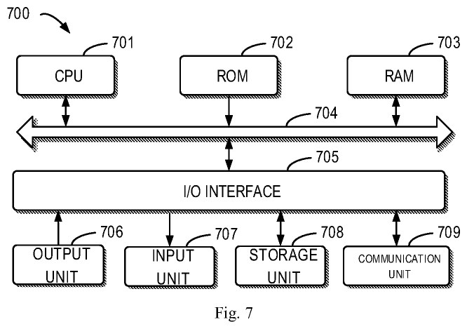

FIG. 7 is a schematic block diagram illustrating an example device 700 that can be used to implement embodiments of the present disclosure. As illustrated, the device 700 includes a central processing unit (CPU) 701 which can perform various suitable acts and processing based on the computer program instructions stored in a read-only memory (ROM) 702 or computer program instructions loaded into a random access memory (RAM) 703 from a storage unit 708. The RAM 703 also stores various types of programs and data required by operating the storage device 700. CPU 701, ROM 702 and RAM 703 are connected to each other via a bus 704 to which an input/output (I/O) interface 705 is also connected.

Various components in the device 700 are connected to the I/O interface 705, including: an input unit 706, such as a keyboard, mouse and the like; an output unit 707, such as a variety of types of displays, loudspeakers and the like; a storage unit 708, such as a magnetic disk, optical disk and the like; and a communication unit 709, such as a network card, modem, wireless communication transceiver and the like. The communication unit 709 enables the device 700 to exchange information/data with other devices via a computer network such as Internet and/or a variety of telecommunication networks.

The processing unit 701 performs various methods and processes as described above, for example, any of the processes 200, 500, 601 and 602. For example, in some embodiments, any of the processes 200, 500, 601 and 602 may be implemented as a computer software program or computer program product, which is tangibly included in a machine-readable medium, such as the storage unit 708. In some implementations, the computer program may be partially or fully loaded and/or installed to the device 700 via the ROM 702 and/or the communication unit 709. When the computer program is loaded to the RAM 703 and executed by the CPU 701, one or more steps of the processes 200, 500, 601 and 602 described above are implemented. Alternatively, in other implementations, CPU 701 may be configured to implement the processes 200, 500, 601 and 602 in any other suitable manners (for example, by means of a firmware).

According to some embodiments of the present disclosure, a computer-readable medium is provided on which a computer program is stored, the program, when executed by a processor, performing a method according to the present disclosure.

Those skilled in the art should understand that various steps of the method of the present disclosure may be performed by a general-purpose computing device, which may be concentrated on a single computing device or distributed on a network composed of multiple computing devices. Optionally, they may be implemented by computing device-executable program code, so that they may be stored on a memory device and executed by a computing device, or they may be separately made into individual integrated circuit modules, or multiple modules or steps may be made into a single integrated circuit module. Thus, the present disclosure is not limited to any specific combination of hardware and software.

It should be understood that although several means or sub-means of the device are mentioned in the above detailed description, such dividing is merely exemplary and not compulsory. In fact, according to the embodiments of the present disclosure, the above described features and functions of two or more means may be embodied in one means. On the contrary, the above described features and functions of one means may further be divided into multiple means.

What has been described above is merely optional embodiments of the present disclosure and is not intended to limit the present disclosure. Various alterations and changes may be made to the present disclosure for those skilled in the art. Any modifications, equivalent replacements and improvements within the spirit and principles of the present disclosure should be included in the protection scope of the present disclosure.

1. An information processing method, comprising:
obtaining product information on a plurality of products, the product information at least comprising an output quantity and a target attribute of each of the plurality of products within a period of time, the output quantity indicating the number of respective products outputted externally within the period of time;
determining a causality related to the output quantity by applying the product information to a data processing model, the causality at least indicating a dependency of the output quantity of each of the plurality of products on the respective target attributes of the plurality of products; and
determining, based on the causality, from the plurality of products at least one target product affecting a total output metric of the plurality of products.

2. The method of claim 1, wherein determining the at least one target product comprises:
determining, based on the dependency, a change of the total output metric caused by a predetermined change of the target attribute of first products of the plurality of products;
in accordance with a determination that the change of the total output metric exceeds a threshold change, determining the first products as candidate products in a set of candidate products; and
determining the at least one target product from the set of candidate products.

3. The method of claim 1, wherein determining the at least one target product comprises:
determining, for second products of the plurality of products, the number of third products based on the dependency, the output quantity of the third products being dependent on the target attribute of the second products, the third products being different from the second products;
in accordance with a determination that the number of the third products exceeds a threshold number, determining the second products as candidate products in a set of candidate products; and
determining the at least one target product from the set of candidate products.

4. The method of claim 2, wherein determining the at least one target product from the set of candidate products comprises:
selecting, from the set of candidate products, a candidate product for which a ratio of the output quantity to the total output metric exceeds a threshold ratio as a target product.

5. The method of claim 1, wherein the product information further comprises at least one of:
a historical target attribute and/or a historical output quantity of each of the plurality of products prior to the period of time,
position information associated with each of the plurality of products,
information on an operation related to at least some of the plurality of products, the operation being used to facilitate outputting of the at least some products externally, or
at least one attribute other than the target attribute of each of the plurality of products.

6. The method of claim 5, further comprising pre-processing the product information so as to be applied to the data processing model.

7. The method of claim 6, wherein the product information comprises the historical output quantity, and pre-processing the product information so as to be applied to the data processing model comprises:
identifying a time characteristic of the period of time based on a comparison between the historical output quantity and the output quantity, the time characteristic indicating whether the period of time is a peak period of outputting products externally; and
wherein determining the causality comprises:
determining a time dependency of the output quantity of each of the plurality of products based on the time characteristic.

8. The method of claim 6, wherein the product information comprises the position information, and pre-processing the product information so as to be applied to the data processing model comprises:
clustering, based on the output quantity of at least some of the plurality of products, a plurality of geographic positions indicated by the position information; and
wherein determining the causality comprises:
determining a position dependency of the output quantity of the at least some of the plurality of products based on a result of the clustering.

9. The method of claim 1, further comprising:
providing information on the at least one target product to an object associated with the plurality of products.

10. The method of claim 1, wherein the data processing model comprises a causality model.

11. An electronic device, comprising:
a processor; and
a memory coupled to the processor, the memory having instructions stored thereon which, when executed by the processor, cause the device to perform acts, the acts comprising:
obtaining product information on a plurality of products, the product information at least comprising an output quantity and a target attribute of each of the plurality of products within a period of time, the output quantity indicating the number of respective products outputted externally within the period of time;
determining a causality related to the output quantity by applying the product information to a data processing model, the causality at least indicating a dependency of the output quantity of each of the plurality of products on the respective target attributes of the plurality of products; and
determining, based on the causality, from the plurality of products at least one target product affecting a total output metric of the plurality of products.

12. The device of claim 11, wherein determining the at least one target product comprises:
determining, based on the dependency, a change of the total output metric caused by a predetermined change of the target attribute of first products of the plurality of products;
in accordance with a determination that the change of the total output metric exceeds a threshold change, determining the first products as candidate products in a set of candidate products; and
determining the at least one target product from the set of candidate products.

13. The device of claim 11, wherein determining the at least one target product comprises:
determining, for second products of the plurality of products, the number of third products based on the dependency, the output quantity of the third products being dependent on the target attribute of the second products, the third products being different from the second products;
in accordance with a determination that the number of the third products exceeds a threshold number, determining the second products as candidate products in a set of candidate products; and
determining the at least one target product from the set of candidate products.

14. The device of claim 12, wherein determining the at least one target product from the set of candidate products comprises:
selecting, from the set of candidate products, a candidate product for which a ratio of the output quantity to the total output metric exceeds a threshold ratio as a target product.

15. The device of claim 11, wherein the product information further comprises at least one of:
a historical target attribute and/or a historical output quantity of each of the plurality of products prior to the period of time,
position information associated with each of the plurality of products,
information on an operation related to at least some of the plurality of products, the operation being used to facilitate outputting of the at least some products to externally, or
at least one attribute other than the target attribute of each of the plurality of products.

16. The device of claim 15, the acts further comprising pre-processing the product information so as to be applied to the data processing model.

17. The device of claim 16, wherein the product information comprises the historical output quantity, and pre-processing the product information so as to be applied to the data processing model comprises:
identifying a time characteristic of the period of time based on a comparison between the historical output quantity and the output quantity, the time characteristic indicating whether the period of time is a peak period of outputting products externally; and
wherein determining the causality comprises:
determining a time dependency of the output quantity of each of the plurality of products based on the time characteristic.

18. The device of claim 16, wherein the product information comprises the position information, and pre-processing the product information so as to be applied to the data processing model comprises:
clustering, based on the output quantity of at least some of the plurality of products, a plurality of geographic positions indicated by the position information; and
wherein determining the causality comprises:
determining a position dependency of the output quantity of the at least some of the plurality of products based on a result of the clustering.

19. The device of claim 11, the acts further comprising:
providing information on the at least one target product to an object associated with the plurality of products.

20. (canceled)

21. A computer-readable storage medium, with a computer program stored thereon which, when executed by a processor, cause the processor to perform a method comprising:
obtaining product information on a plurality of products, the product information at least comprising an output quantity and a target attribute of each of the plurality of products within a period of time, the output quantity indicating the number of respective products outputted externally within the period of time;
determining a causality related to the output quantity by applying the product information to a data processing model, the causality at least indicating a dependency of the output quantity of each of the plurality of products on the respective target attributes of the plurality of products; and
determining, based on the causality, from the plurality of products at least one target product affecting a total output metric of the plurality of products.
